(19) United States
(12) Patent Application Publication
(10) Pub. No.: US 2016/0088046 A1
(43) Pub. Date: Mar. 24, 2016

(54) REAL TIME CONTENT MANAGEMENT SYSTEM

(71) Applicant: Multipop LLC, Oak Park, IL (US)

(72) Inventors: Joshua Lamb, Oak Park, IL (US); Steven E. Harshbarger, Corte Madera, CA (US)

(21) Appl. No.: 14/834,318

(22) Filed: Aug. 24, 2015

Related U.S. Application Data
(63) Continuation-in-part of application No. 14/490,639, filed on Sep. 18, 2014.

(51) Int. Cl. H04L 29/06; H04L 29/08; G06F 17/30

(52) U.S. Cl. CPC H04L 65/60; G06F 17/30076; G06F 17/30058; H04L 67/10

(57) ABSTRACT

A system is provided. The system includes a content database that stores content that is generated by a content producer computing device. Further, the system includes a processor that defines an event according to event data, establishes a start time for the event, associates a content item from the content database with the event, reschedules the content item in real time after the start time, receives a polling request for content, and determines content to be played at a time associated with the polling request. The system also includes a transmitter that transmits the content item at a time corresponding to the time span added to the start time.

### RELATED APPLICATIONS

This patent application is a Continuation-In-Part patent application of U.S. patent application Ser. No. 14/490,639, filed on Sep. 18, 2014, entitled MEDIA PLATFORM FOR ADDING SYNCHRONIZED CONTENT TO MEDIA WITH A DURATION.

### BACKGROUND

1. Field

This disclosure generally relates to the field of computing systems. More particularly, the disclosure relates to media players.

2. General Background

Current media systems are limited in their ability to allow authors to customize content for videos displayed in video players. For instance, an author may want to add content to an existing video so that a user may view a video with the additional content. That author currently has to be able to manually prepare code, e.g., html code, that would add such content with the video.

Such a manual coding process is cumbersome and tedious. The author has to prepare significant amounts of code to perform even simple tasks. Further, such an authoring process does not have a visual design component. As a result, the authoring process is more concentrated on coding rather than designing the visual appearance of a layout with a video and additional content.

The authoring process is also limited to authors that are familiar with coding. Therefore, potential authors are prevented from authoring layouts for videos and additional content. Thus, current media systems are not adequate for providing the ability to add content to media.

### SUMMARY

A system is provided. The system includes a content database that stores content that is generated by a content producer computing device. Further, the system includes a processor that defines an event according to event data, establishes a start time for the event, associates a content item from the content database with the event, reschedules the content item in real time after the start time, receives a polling request for content, and determines content to be played at a time associated with the polling request. The system also includes a transmitter that transmits the content item at a time corresponding to the time span added to the start time.

Further, another system is provided. The system includes a content database that stores content that is generated by a content producer computing device. The system also includes a processor that defines an event according to event data, establishes a start time for the event, associates a content item from the content database with the event, reschedules the content item in real time after the start time, receives a polling request for content, and determines content to be played at a time associated with the polling request. Further, the system includes a transmitter that transmits the content item at a time corresponding to the time span added to the start time.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a media configuration.

FIGS. 2A-2C illustrate examples of screen displays that may be utilized during the authoring process at the author computing device illustrated in FIG. 1.

FIG. 2A illustrates a media configuration display screen.

FIG. 2B illustrates a popup configuration display screen that may be utilized by the author 102 to generate content synchronization data.

FIG. 2C illustrates a popup generation display screen.

FIGS. 3A and 3B illustrate screen displays displayed by the media player illustrated in FIG. 1.

FIG. 3A illustrates a media player display screen.

FIG. 3B illustrates a media player display screen that displays images of each popup.

FIG. 4 illustrates a content data synchronization configuration.

FIG. 5 illustrates a process that is utilized to provide content modification and interaction.

FIG. 6 illustrates a real time content management configuration that delivers content according to a schedule.

FIG. 7 illustrates a process that is utilized to deliver scheduled content according to the real time content management configuration illustrated in FIG. 6.

FIG. 8 illustrates a real time content management configuration that delivers content in real time.

FIG. 9 illustrates a process that is utilized to deliver content in real time according to the real time content management configuration illustrated in FIG. 6.

FIG. 10 illustrates an example of the real-time graphical user interface (“GUI”) illustrated in FIG. 8.

FIG. 11 illustrates another example of the real-time GUI illustrated in FIG. 8.

FIG. 12 illustrates yet another example of the real-time GUI illustrated in FIG. 8.

### DETAILED DESCRIPTION

A media system may be utilized to add content to media with a time duration. The media system allows authors to visually generate a layout for both media with a time duration, e.g., video and/or audio, and additional content through a user interface. The authors are not required to have any understanding of coding.

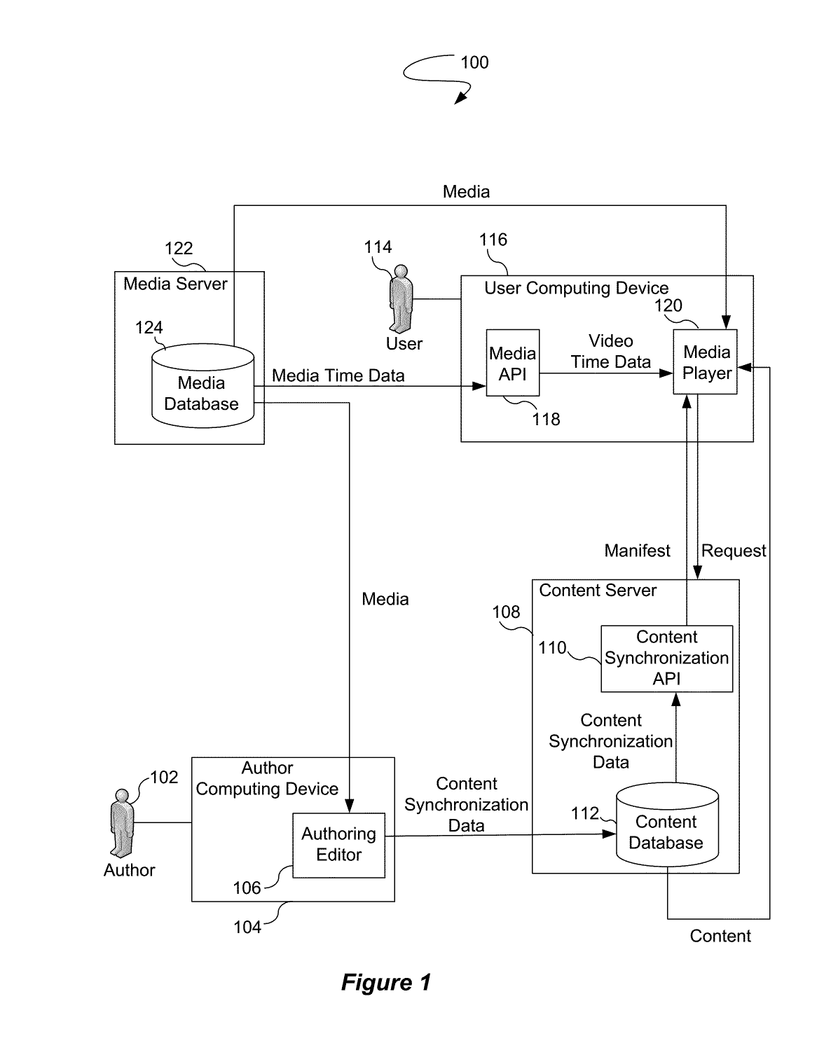

FIG. 1 illustrates a media configuration 100. The media configuration 100 includes an author computing device 104 for an author 102 and a user computing device 116 for a user 114. The author 102 utilizes the author computing device 104 to author a layout for media with a time duration and additional content so that the user 114 may play media with the additional content at the user computing device 116. For ease of illustration, the author computing device 104 and the user computing device 116 are illustrated as different devices for an author 102 that is distinct from a user 114. If the author 102 and the user 114 are the same person, a single device may be utilized for the author computing device 104 and the user computing device 116. For example, the author may want generate a preview of the layout or generate the layout for personal consumption.

The author computing device 104 may be a personal computer, laptop computer, smartphone, smartwatch, tablet device, other type of mobile computing device, etc. The author 102 accesses an authoring editor 106 to prepare a layout for media and additional content. In one embodiment, the authoring editor 106 is a set of code, e.g., a software application, that is stored on the author computing device 104. For example, the author 102 utilizing a tablet device for the author computing device 104 may download a software application for the authoring editor 106 that is then stored on the author computing device 104. As another example, the tablet device may have the authoring editor 106 preloaded. In another embodiment, the authoring editor 106 may be stored in a cloud computing environment and then accessed and rendered via a web browser on the author computing device 104.

The media configuration 100 also has a content server 108 and a media server 122. The content server 108 communicates with the author computing device 104 to store data for the layout generated by the author computing device 104. The media server 122 stores the media, e.g., video and/or audio, to which content is being added. Therefore, distinct servers 108 and 122 are utilized to store each of the additional content and media. As a result, the media configuration 100 allows for authoring a layout independently of any particular media server or media player.

The authoring editor 104 receives media from the video server 122. For example, the author 102 searches a website for a particular cooking video and then plays that cooking video within the authoring editor 106 to determine content synchronization data, i.e., times during the cooking video to place the additional content so that the additional content will appear in a synchronized manner at those times during playback of the media. For instance, the additional content may be a link to a website to purchase the cooking items that appear in the media at the times provided by the synchronization data. The additional content may be a variety of content, e.g., images, text, questions to the viewer, links to social media to share data, etc. The authoring editor 106 may be accessed from a cloud computing environment such as the content server 108 and rendered in a web browser on the author computing device 102.

The author computing device 104 sends the content synchronization data to the content server 108. The content server 108 has a content synchronization Application Programming Interface (“API”) 110 and a content database 112. The content server 108 stores the content synchronization data in the content database 112. For instance, the content server 108 may generate a new entry in the content database 112 for a new layout received from the author computing device 104. The content server 108 may assign the new layout an identifier, e.g., a number. The content server 108 may then store content synchronization data for that layout identifier and any updates to the content synchronization data according to that layout identifier. Therefore, the author 102 may work on different layouts and store new or updated content synchronization data based upon the layout identifier in the content server database 112. The content synchronization data may be stored until a request is received from the user computing device 116.

The user computing device 106 includes a media API 118 and a media player 120. The media player 120 may be downloaded from the content server 108 or another server, may be prestored on the computing device 106, or may be accessed through a cloud computing environment such as the content server 108 and rendered on the user computing device 116. The media player 120 is preprogrammed with logic or provided with logic that provides a link to the content server 108. For instance, the media player 120 may be embedded in a website, e.g., a cooking store website. The user 114 utilizes the user computing device 116 to access the website through a web browser and render the media player 120 in the web browser. The media player has logic that is utilized to request the additional content data from the content server 108. In one embodiment, the media player 120 stores a particular layout identifier and sends that layout identifier as part of the request. Upon receiving the request, the content server 108 retrieves the content synchronization data associated with the layout identifier from the content database 112. The content server 108 then utilizes the content synchronization API 110 to automatically generate a manifest, e.g., code, based upon the content synchronization data. For instance, JavaScript Object Notation (“JSON”) may be utilized as the code for the manifest. The author 102 provides inputs through a user interface as to the additional content and the times for the additional content to be played in synchronization with the media. The content server 108 may provide the human readable content synchronization data to the content synchronization API 110 to generate a manifest in JSON. The content server 110 may then send the manifest to the media player 120 at the user computing device 116. The media player 120 then automatically generates HTML code so that the additional content may be rendered by the media player 120.

The user computing device 116 receives the media for playback from the media server 122. Further, the user computing device 116 may utilize the media API 118 to obtain media time data from a media database 124 at the media server 122 that stores the media and associated time data. For instance, the media player 120 streams the media from the media server 122 for playback, obtains the additional content from the content server 108, obtains the content synchronization data from the content server 108, and obtains the current media time playback data from the media server 122. Therefore, the media player 120 may render the layout determined by the author 102, find out the current time of media playback from the media server 122, and render the additional content based upon that current media playback time and the content synchronization data. The media player 120 may be embedded in a variety of contexts, e.g., websites, blogs, etc.

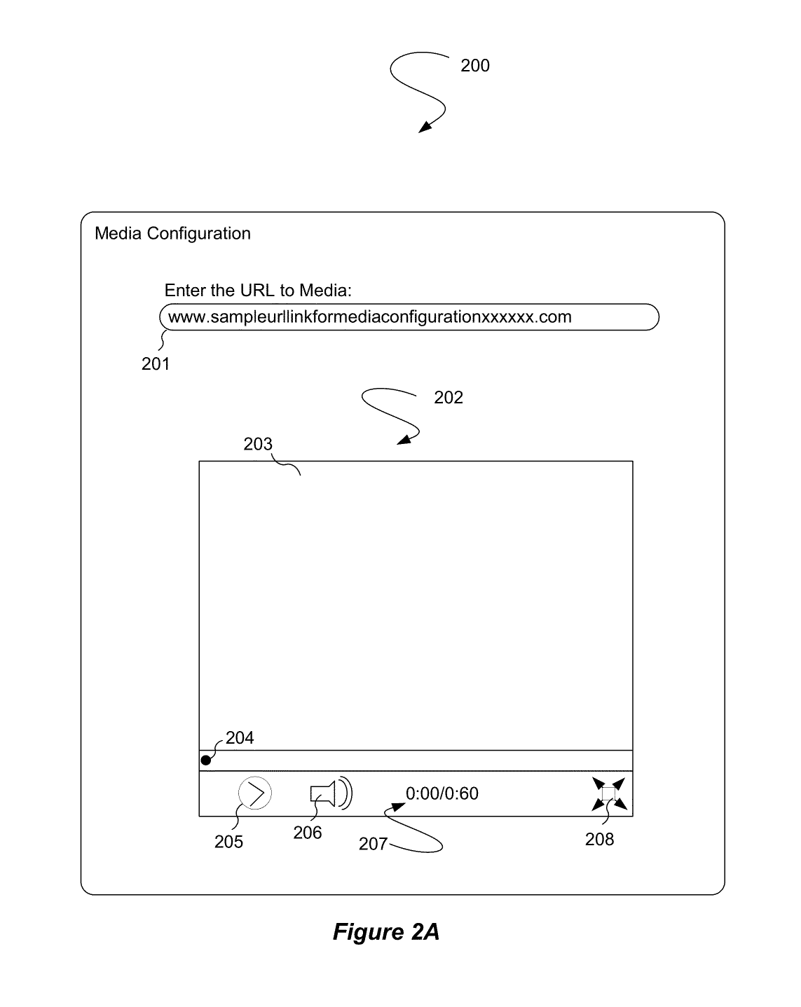

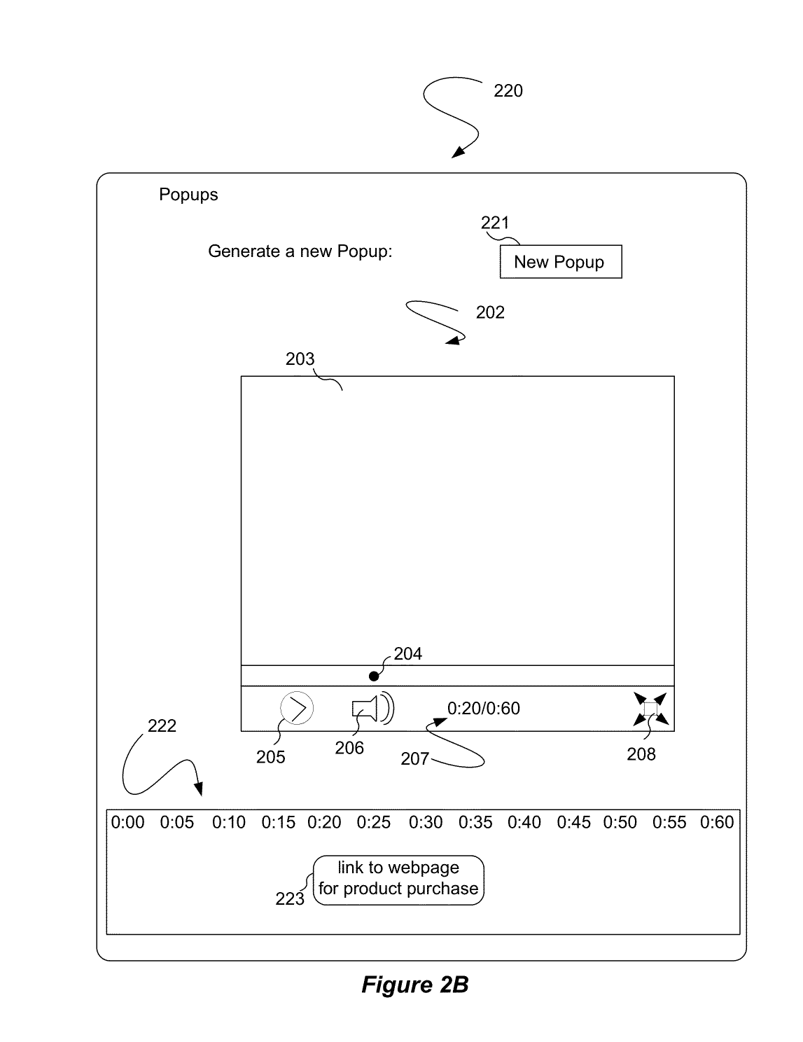

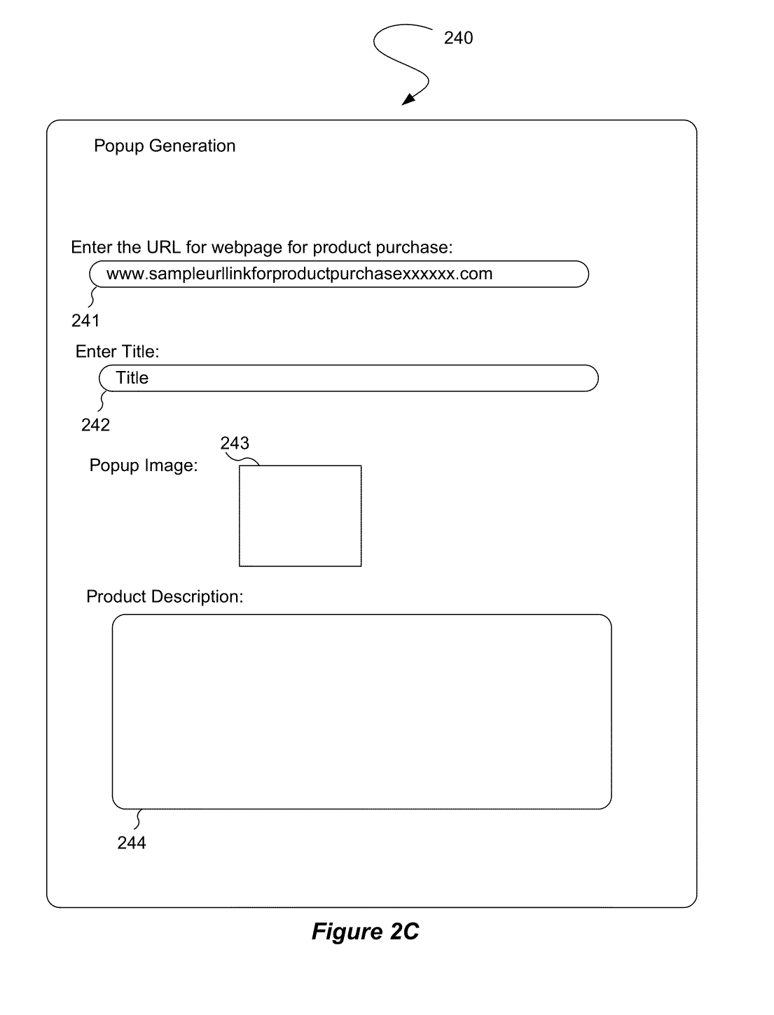

FIGS. 2A-2C illustrate examples of screen displays that may be utilized during the authoring process at the author computing device 104 illustrated in FIG. 1. FIG. 2A illustrates a media configuration display screen 200. The media configuration display screen 200 is utilized by the author 102 to determine the particular media upon which the author 102 wants to base a layout. For instance, the author 104 may input a URL link to a video at a media input field 201.

The author 104 may then preview the media through a media player 202. The media player 202 has a display screen 203, a timeline indicium 204, a play/pause indicium 205, an audio volume indicium 206, a timeline time indicium 207, and a screen dimension adjustment indicium 208. The timeline indicium 204 displays the time in the video at which the timeline indicium 204 is positioned.

FIG. 2B illustrates a popup configuration display screen 220 that may be utilized by the author 102 to generate content synchronization data. The author 102 may preview the media in the media player 202 in the popup configuration display screen 202. After reaching a position in the media at which the author wants to add content, the author 102 may generate a new popup by selecting a new popup indicium 221. The author 102 may then utilize a timeline synchronization display 222 to add a popup 223 at the particular times that the author wants the popup synchronized with the media content. For instance, the author 102 may preview a cooking video and notice that a pair of cooking tongs are displayed for a duration from twenty seconds to thirty five seconds of the video. The author 102 may then utilizer a timeline slider, e.g., a cursor or other dragging feature, to drag the section of the timeline synchronization display 222 corresponding to the duration of twenty seconds to thirty five seconds. The popup 223 is then displayed in the timeline synchronization display 222 for that duration. The user 114 will then view the popup 223 during that time period in synchronization with playback of the media. For instance, the popup 223 may be a link to a webpage for product purchase of the pair of tongs. The user 114 may click on the popup 223 to obtain an expanded popup screen to get more information about the product and/or be redirected to a webpage at which the user 114 may purchase the product.

Although a single popup 223 has been illustrated for ease of illustration, the author 102 may insert a plurality of popups in the timeline synchronization display 222. The plurality of popups may be at the same time, different times, and/or overlapping times. Further, the popups may be different, e.g., links to webpages, images, text, questions, etc. Therefore, the author 102 is able to visually add content to media in a synchronized manner by visually adding popups to a timeline without having to manually prepare any code.

FIG. 2C illustrates a popup generation display screen 240. The popup generation display screen 240 allows the author 102 to input information for the popup 223 illustrated in FIG. 2B. For instance, the author 102 may input a URL link for product purchase at a product purchase URL input field 241, a title at a title input field 242, a popup image to be displayed for the popup 223 at a popup image field 243, and a product description at a product description field 244.

The author 102 may also provide click through requirements through various screen displays. For example, the author 102 may provide payment to an entity operating the content server 108 based upon a quantity of clicks of a particular popup. The author 102 may provide a budget input so that the content server 108 is aware of when the content synchronization data should or should not be provided depending upon a quantity of clicks and the budget input. Further, the author 102 may also provide scheduling requirements through various screen displays such that certain popups should or should not be available at certain times. The content server 108 is then aware of when to send or not send certain portions of the content synchronization data, e.g., the author 102 may only want a particular popup for merchandise to be displayed during a sale.

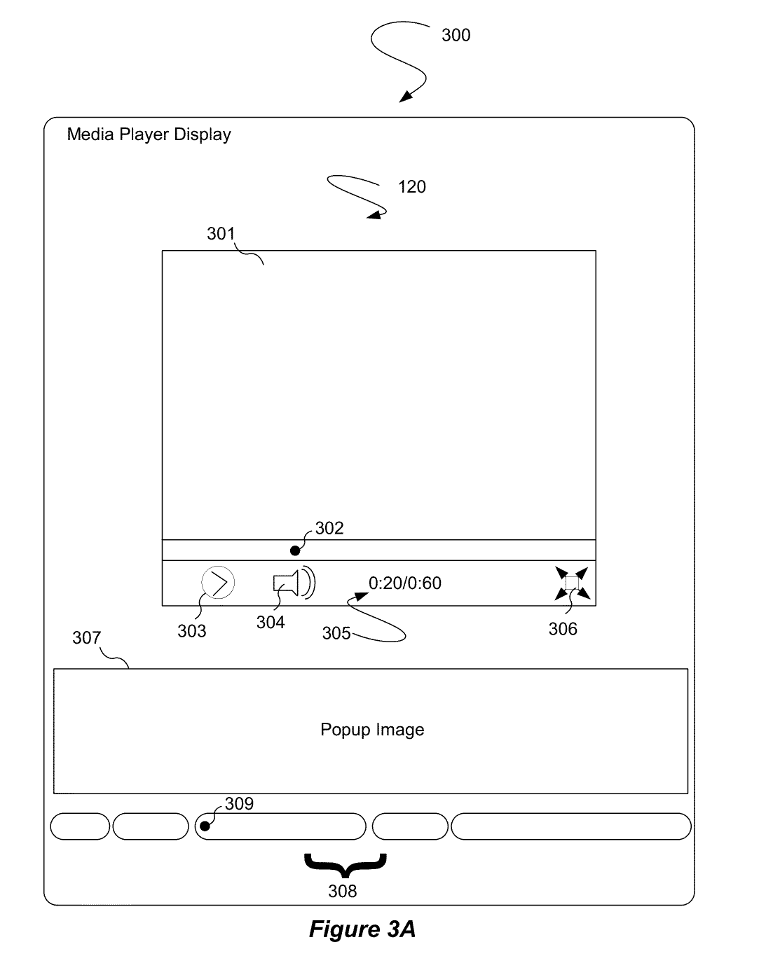

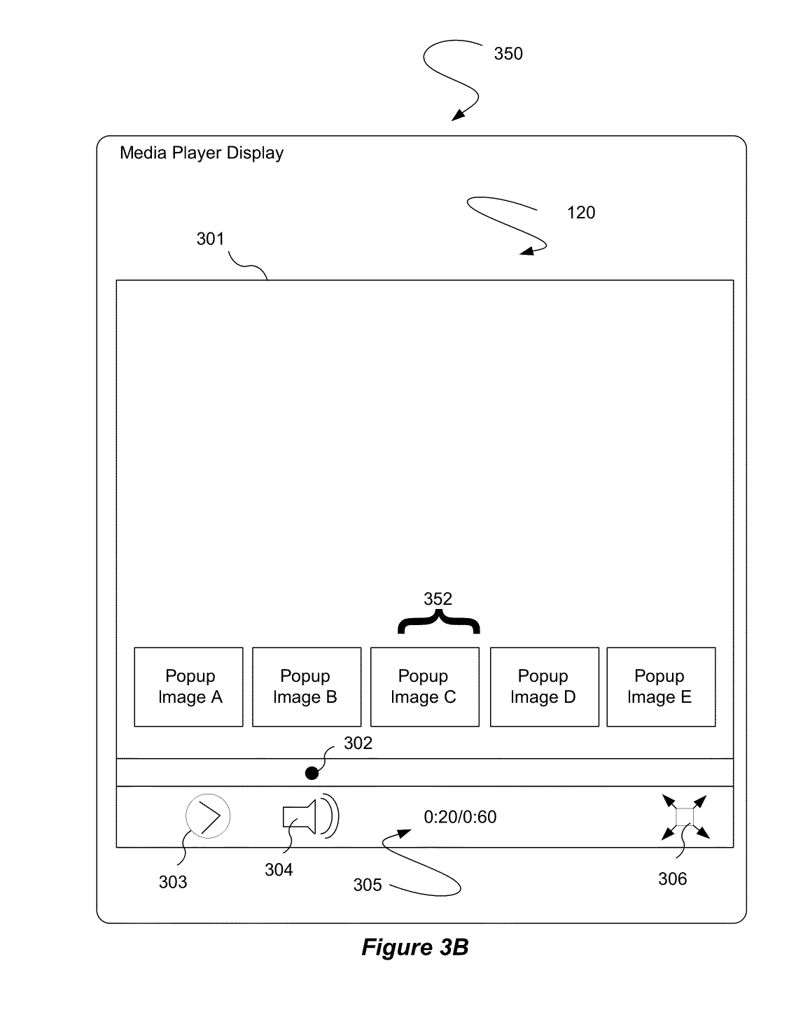

FIGS. 3A and 3B illustrate screen displays displayed by the media player 120 illustrated in FIG. 1. FIG. 3A illustrates a media player display screen 300. The media player display screen 300 displays the synchronized layout prepared by the author 102. The media player display screen 300 displays the media player 120. The media player 120 has a display screen 301, a timeline indicium 302, a play/pause indicium 303, an audio volume indicium 304, a timeline time indicium 305, and a screen dimension adjustment indicium 306. The timeline indicium 302 displays the time in the video at which the timeline indicium 302 is positioned.

A popup image display screen 307 displays a popup that is synchronized with a current time as provided for by the layout authored by the author 102 with the content synchronization data received from the manifest. After the duration for the popup image completes, a next popup may be displayed according to a subsequent time duration provided by the content synchronization data from the manifest. Although a single popup image display screen 307 is displayed for ease of illustration, multiple popup image displays screens 307 or multiple popups may be displayed in the popup image display screen 307 if the author 102 authored multiple popups for a particular time duration of the media.

In one embodiment, a plurality of popup timeline status displays may be utilized. As each popup is being displayed, a popup timeline indicium in a corresponding timeline status display may be displayed. The user 102 may click on the popup image display screen 307 to obtain an expanded view and obtain more information about the popup.

FIG. 3B illustrates a media player display screen 350 that displays images of each popup. The user 102 may select from a plurality of popup images 352 to obtain an expanded view and obtain more information about the selected popup.

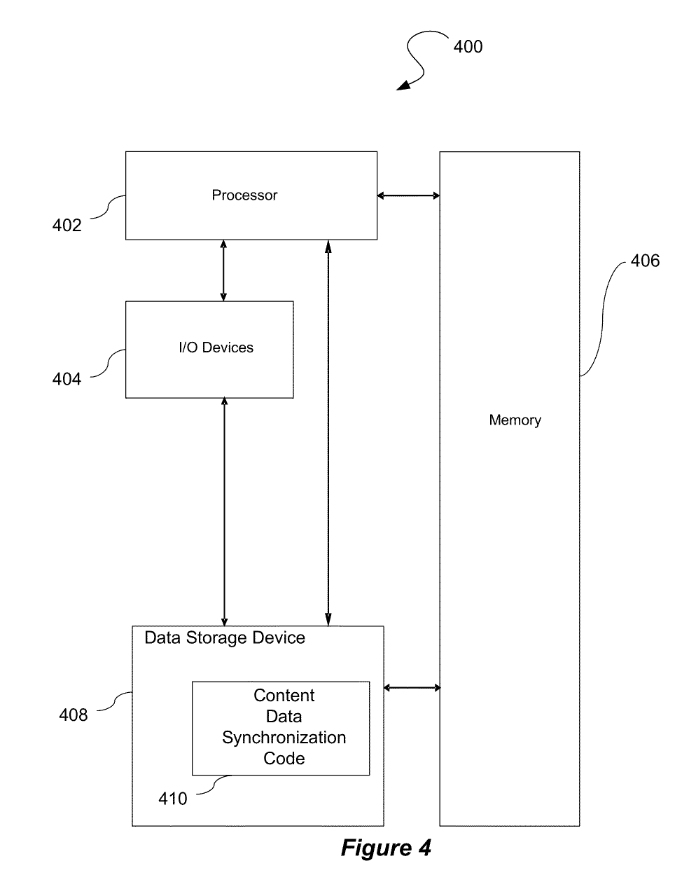

FIG. 4 illustrates a content data synchronization configuration 400. In one embodiment, the content data synchronization configuration 400 is implemented utilizing a general purpose computer, e.g., a server computer, or any other hardware equivalents. Thus, the content data synchronization configuration 400 comprises a processor 402, various input/output devices 404, e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device such as a keyboard, a keypad, a mouse, and the like, or a microphone for capturing speech commands, a memory 406, e.g., random access memory (“RAM”) and/or read only memory (ROM), a data storage device 408, and content data synchronization code 410.

The content data synchronization code 410 may be implemented as a set of computer readable instructions that may be utilized by the processor 402 in the memory 406 to perform various actions associated with content modification and interaction. The content data synchronization code 410 may be represented by one or more software applications, where the software is loaded from a storage medium, e.g., a magnetic or optical drive, diskette, or non-volatile memory, and operated by the processor 402 in the memory 406 of the computer. As such, the content data synchronization code 410 including associated data structures of the present disclosure may be stored on a computer readable medium, e.g., RAM memory, magnetic or optical drive or diskette and the like. As an example, the content data synchronization code 410 may be implemented as an application that is downloaded onto a smartphone or tablet device.

Alternatively, the content data synchronization code 410 may be implemented as one or more physical devices that are coupled to the processor 402. The content data synchronization code 410 may be utilized to implement any of the configurations herein.

The content data synchronization configuration 400 may be implemented on a computing device. A computing device may be a server computer, personal computer, laptop, notebook, smartphone, smartwatch, tablet device, other type of mobile deice, etc.

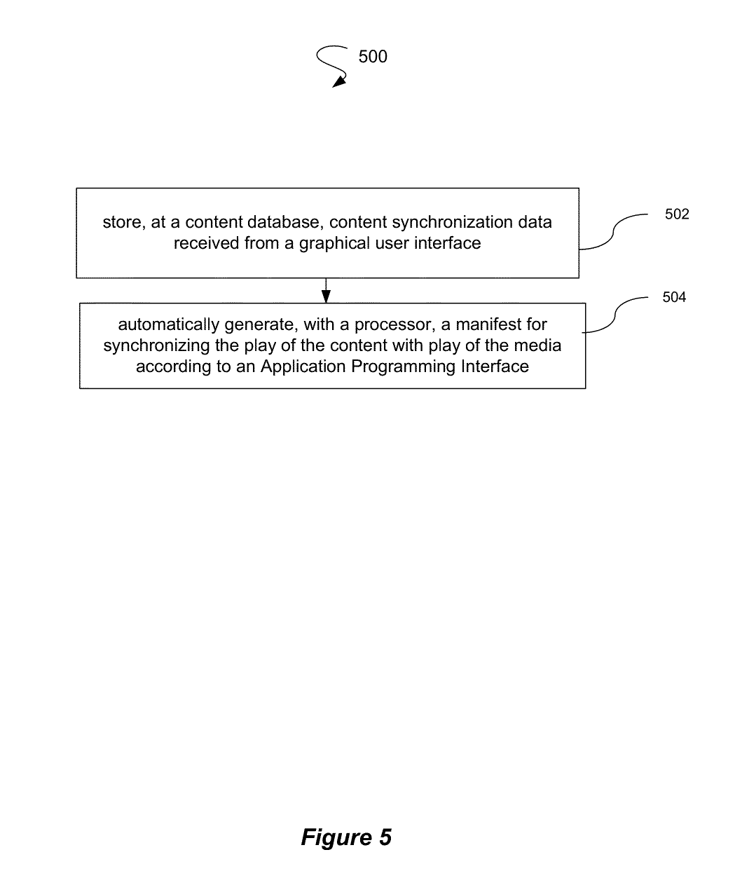

FIG. 5 illustrates a process 500 that is utilized to provide content data synchronization. At a process block 502, the process 500 stores, at a content database, content synchronization data received from a graphical user interface. The content synchronization data has a location of media, a set of content, a content start time, and a content end time. The content start time is a time in the media at which play of the content is to start. The content end time is a time in the media at which the play of the content is to end. Further, at a process block 504, the process 500 automatically generates, with a processor, a manifest for synchronizing the play of the content with play of the media according to an Application Programming Interface.

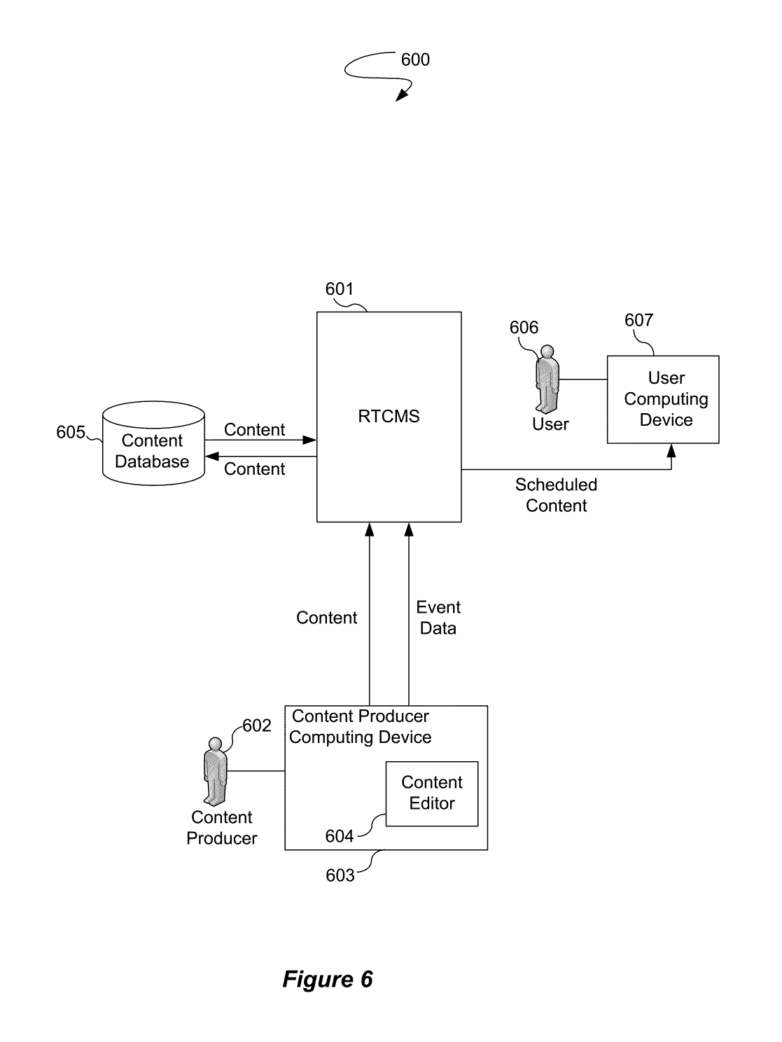

FIG. 6 illustrates a real time content management configuration 600 that delivers content according to a schedule. The real time content management configuration has a real time content management system 601 (“RTCMS”). The RTCMS 601 provides an interface for content producers to determine what content is displayed at a current point in time. For example, the RTCMS 601 allows applications such as presenting content related to a live event being broadcasted over television or streamed web video. Examples of the live event include sporting events, awards shows, and live product demonstrations.

A content producer 602, which may be a human or a machine, utilizes a content producer computing device, e.g., PC, laptop, tablet device, smartphone, etc., to generate content. For example, the content producer 602 may utilize a content editor 604 to generate and/or modify content. For instance, the content producer 602 may utilize the content editor 604 to generate and/or edit content templates for merchandise, comments, votes, images, videos, audio, etc.

The RTCMS 601 receives the content generated by the content producer 602 and stores the content in a content database 605. Further, the content producer 602 defines event data, which is time based data that is associated with an event. For example, the event data may include a scheduled start time for the event and time span, i.e., a time period that is determined from the start time, from which content is distributed. The content producer 602 also sends the event data to the RTCMS 601. The RTCMS 601 is then aware of the time at which the content producer 602 intended for the content to be sent to a user 606 associated with a user computing device 607. The time span may be determined prior to the event. Alternatively, the time span may be determined during a live event. The event data may also include other data such as a content producer generated name for the event, e.g., a name for a show determined by the content producer 602.

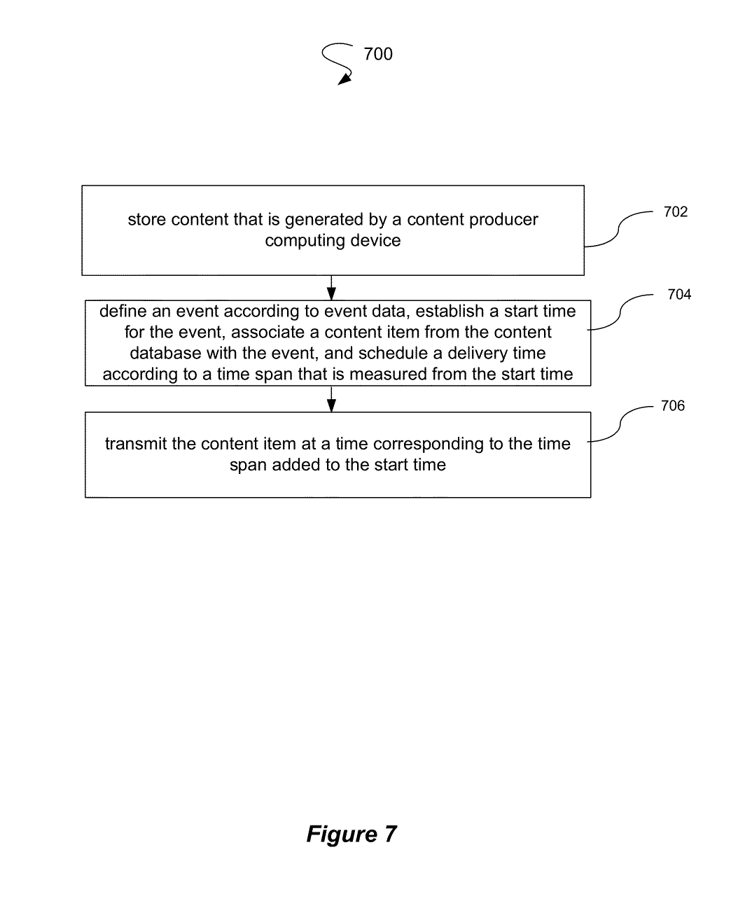

FIG. 7 illustrates a process 700 that is utilized to deliver scheduled content according to the real time content management configuration 600 illustrated in FIG. 6. At a process block 702, the process 700 stores content that is generated by a content producer computing device. Further, at a process block 704, the system includes a processor that defines an event according to event data, establishes a start time for the event, associates a content item from the content database with the event, reschedules the content item in real time after the start time, receives a polling request for content, and determines content to be played at a time associated with the polling request. The system also includes a transmitter that transmits the content item at a time corresponding to the time span added to the start time.

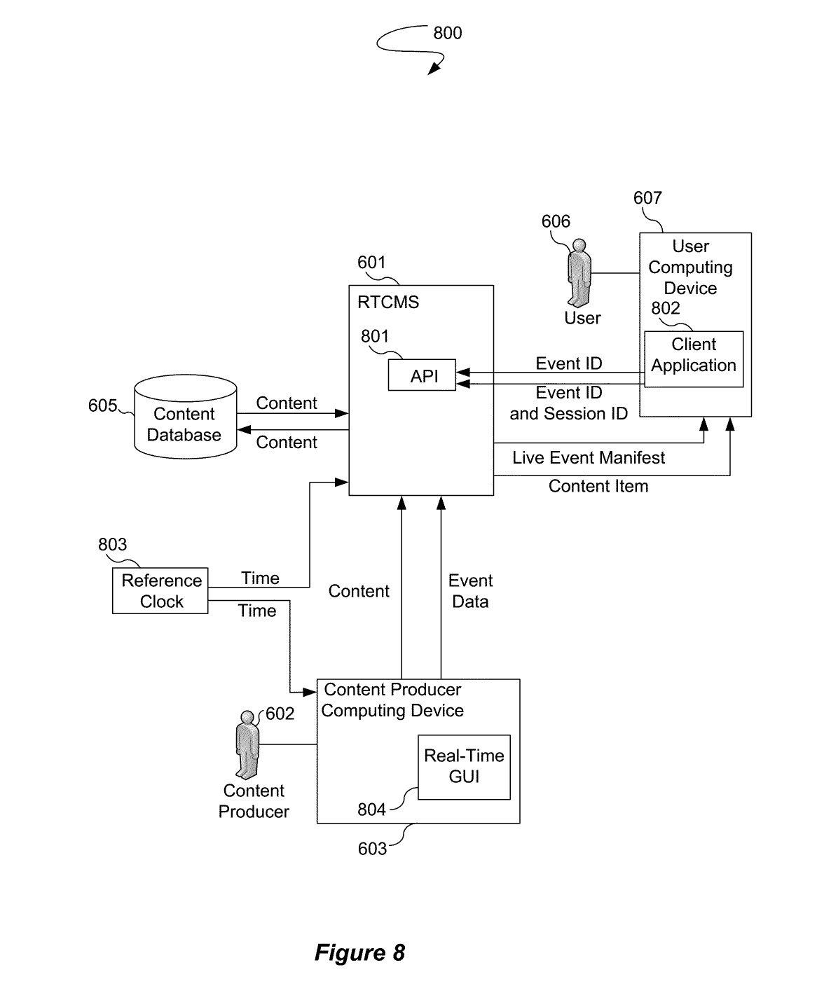

FIG. 8 illustrates a real time content management configuration 800 that delivers content in real time. The real time content management configuration 800 has an Application Programming Interface (“API”) 801 that is stored on the RTCMS 601. A client application 802 is stored on the user computing device 607. The client application 802 polls, e.g., through a polling loop, the API 801 to determine what content should be played in real-time at the current time for a particular event.

The API 802 obtains an event identifier. The event identifier is the same for each user computing device 607. For example, the API 802 may obtain a public event identifier through a webpage, a push notification, etc. The API 802 sends the event identifier to the API through an initial function call to the API when the client application 802 tunes in to the event. For example, the client application 802 tunes into an event when the client application 802 changes a channel on the user computing device 607 to obtain the corresponding content. The RTCMS 601 then sends a live event manifest to the client application 802. The live event manifest includes a session identifier, the event name, and content formatting or styling data. The session identifier is a unique identifier that identifiers the session between the RTCMS 601 and the client application 802. The session identifier allows the client application 802 to provide data unique to the user 606, the user computing device 607, and/or the particular session between the RTCMS 801 and the client application 802. Such data allows the client application 802 to generate analytics, adjust the content experience for the user 606, etc.

To obtain the current content item, the client application 802 then enters a polling loop by sending the event identifier and the session identifier to the API 801 at a given rate until the API 801 provides the client application 802 with a content item. For example, the client application 802 may send the event identifier and the session identifier to the API 801 once each second to poll the API 801. An example of polling the API 801 is the client application 802 asking the API 801 if the API 801 wants any particular content to be currently displayed in real time by the client application 802. The RTCMS 801 monitors the reference clock 803 to determine if any content is to be displayed at the time provided by the reference clock 803. If scheduled or rescheduled content corresponding to a particular time is to be displayed, the RTCMS 801 provides that content to the client application 802 for display at the user computing device 607.

Further, the RTCMS 601 and the content producer computing device 603 are synchronized to the same time by receiving the current time from a reference clock 803, e.g., a clock that is accessible through a network connection. The client application 802 requests the time from the RTCMS 601 so that the client application 802 is synchronized with the RTCMS 601 and the content producer computing device 603. The content producer computing device 603 has a real-time graphical user interface 804 that the content producer 602 may utilize to reschedule content items during an event. For example, the content producer 602 may change the time span from the start time of the event while the event is in progress. The client application 802 displays the content items in real time based on the current time maintained by the RTCMS 601. In an alternative configuration, the client application 802 may determine the time independently of the RTCMS 601 and request the content based on that time.

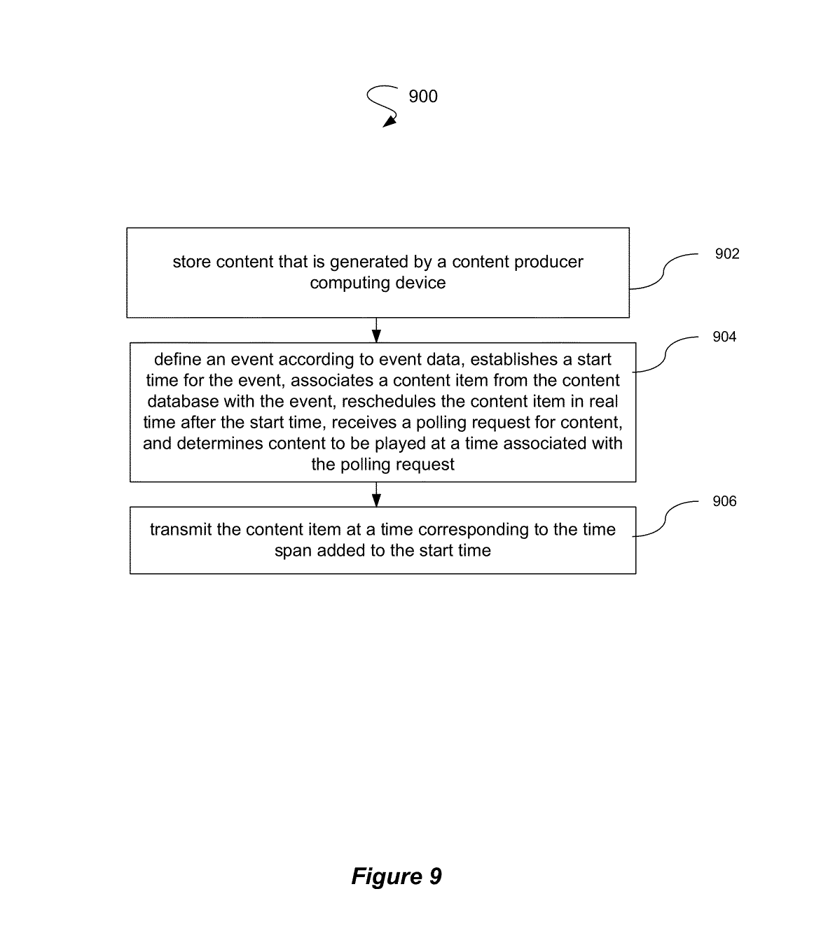

FIG. 9 illustrates a process 900 that is utilized to deliver content in real time according to the real time content management configuration 800 illustrated in FIG. 6. At a process block 902, the process 900 stores content that is generated by a content producer computing device. Further, at a process block 904, the process 900 defines an event according to event data, establishes a start time for the event, associates a content item from the content database with the event, reschedules the content item in real time after the start time, receives a polling request for content, and determines content to be played at a time associated with the polling request. Further, at a process block 906, the process 900 transmits the content item at a time corresponding to the time span added to the start time.

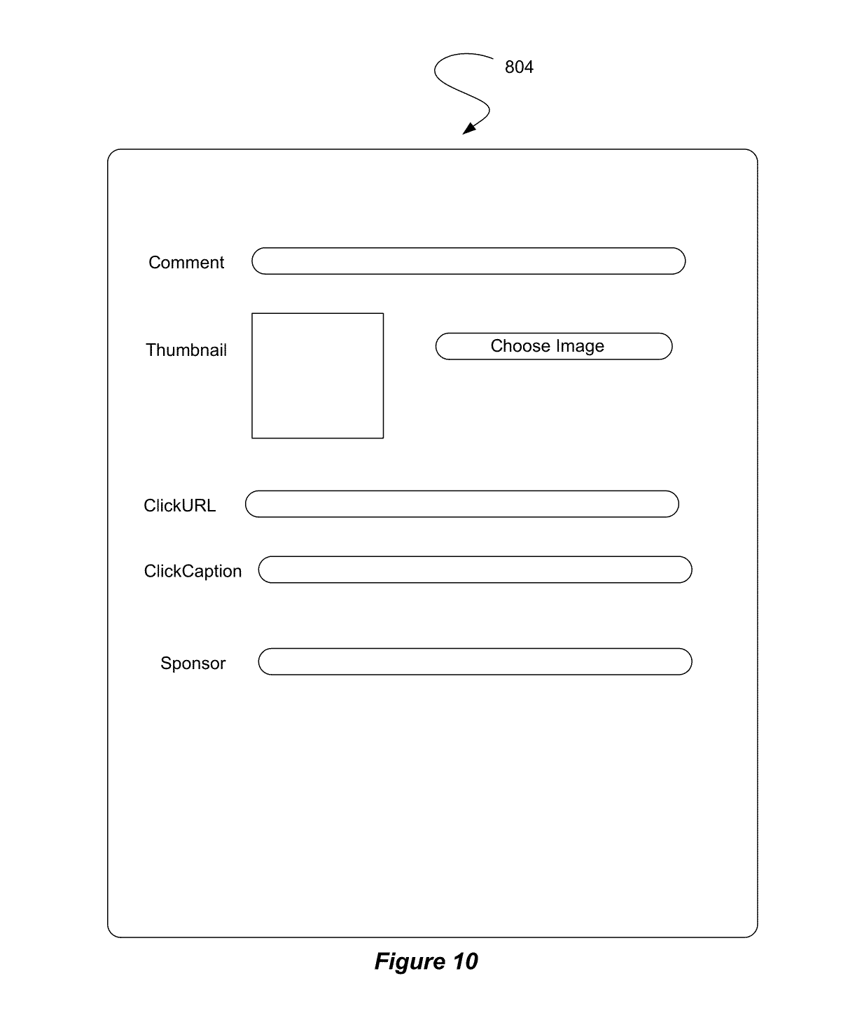

FIG. 10 illustrates an example of the real-time GUI 804 illustrated in FIG. 8. The real-time GUI 804 allows the content producer 602 to upload various content items and add various text to be displayed with the content, e.g., comments, URLs, captions, sponsors, etc.

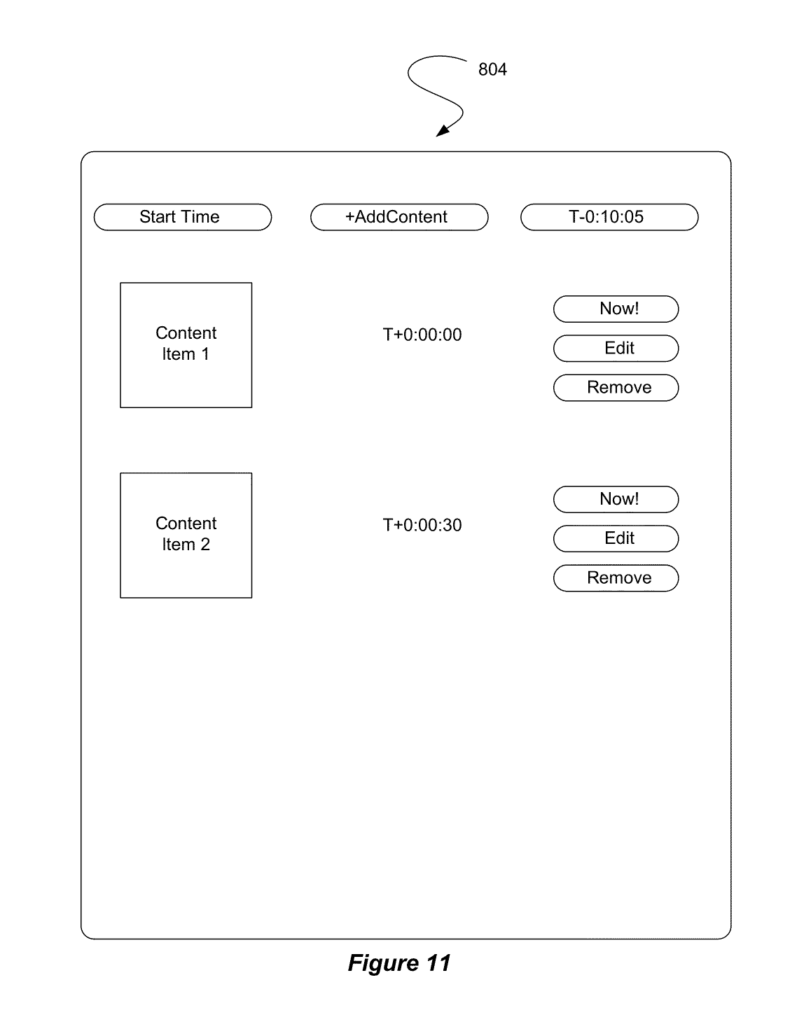

FIG. 11 illustrates another example of the real-time GUI 804 illustrated in FIG. 8. The content producer 602 may schedule different content items at various time spans from a start time. For example, the content producer 602 may schedule the content items prior to the event, e.g., ten minutes and five seconds prior to the start time of the event. The content producer 602 may then schedule different content items to be delivered to the user computing device 607. For example, the content producer 602 may schedule a first content item to be delivered at the start of the event and a second content item to be delivered thirty seconds after the start of the event.

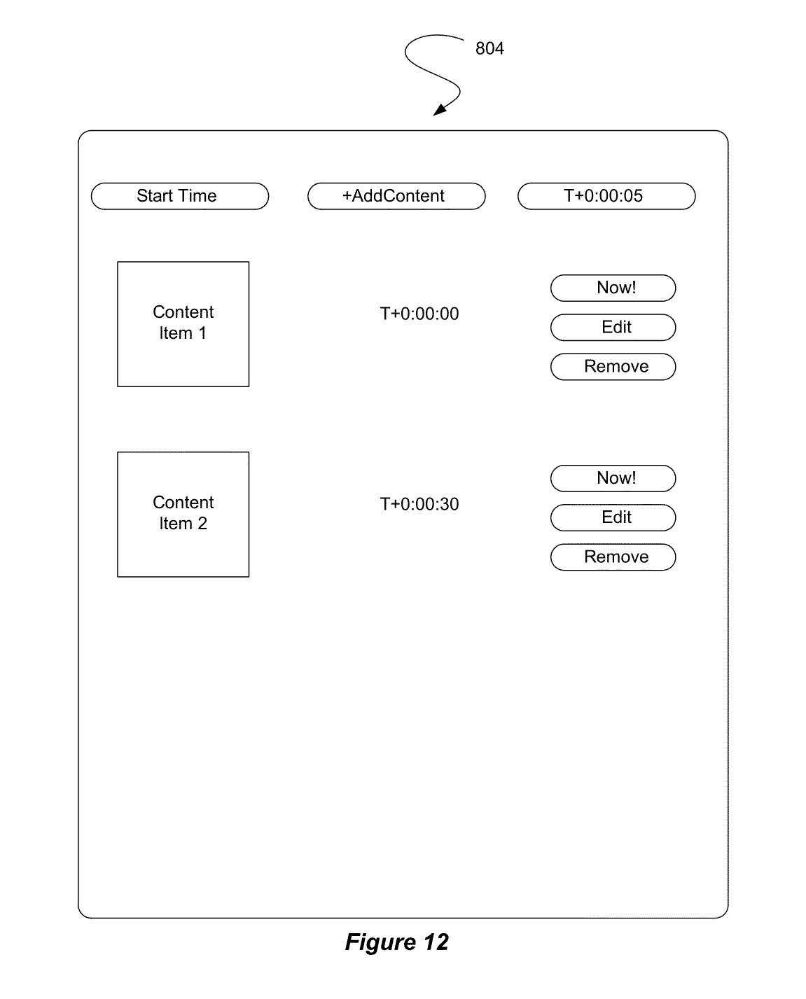

FIG. 12 illustrates yet another example of the real-time GUI 804 illustrated in FIG. 8. The content producer 602 may reschedule different content items at various time spans from a start time during the live event, e.g., five seconds after the start of the live event. For example, the content producer 602 may reschedule the second content item from thirty seconds after the start of the live event to two minutes and thirty seconds after the start of the live event. The content producer 602 may select various buttons such as a shortcut to reschedule a content item for current delivery, editing of the content item, or removal of the content item.

Although polling is described as a method for the client application 802 to ask the API 801 if any content should be displayed, other forms of communication between the client application 802 and the API 801 may implemented to obtain such determination. For example, the client application 802 may open a persistent connection with the RTCMS 601 so that the RTCMS 601 may push real time content through the connection as the reference clock 803 advances to a different time, time span, etc. For instance, the API 801 may be utilized by the RTCMS 601 to effectuate such communications. Polling and a persistent connection are just examples of communication between the client application 802 and the API 801 as a variety of other forms of communication may be utilized.

A computer program product may be utilized to store a computer readable program. As an example, the computer program product may be a computer readable storage device that is non-transitory. The computer readable program when executed on a computer causes the computer to perform the processes described herein for any such configurations.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium such as a computer readable storage device. The instructions may also be created using source code or any other known computer-aided design tool. A computer readable medium may be any medium capable of carrying those instructions and include a CD-ROM, DVD, magnetic or other optical disc, tape, silicon memory, e.g., removable, non-removable, volatile or non-volatile, packetized or non-packetized data through wireline or wireless transmissions locally or remotely through a network. A computer is herein intended to include any device that has a general, multi-purpose or single purpose processor as described above.

It is understood that the processes, systems, apparatuses, and compute program products described herein may also be applied in other types of processes, systems, apparatuses, and computer program products. Those skilled in the art will appreciate that the various adaptations and modifications of the embodiments of the processes, systems, apparatuses, and compute program products described herein may be configured without departing from the scope and spirit of the present processes and systems. Therefore, it is to be understood that, within the scope of the appended claims, the present processes, systems, apparatuses, and compute program products may be practiced other than as specifically described herein.

We claim:

1. A system comprising:
a content database that stores content that is generated by a content producer computing device;
a processor that defines an event according to event data, establishes a start time for the event, associates a content item from the content database with the event, and schedules a delivery time according to a time span that is measured from the start time; and
a transmitter that transmits the content item at a time corresponding to the time span added to the start time.

2. The system of claim 1, wherein the content is video and/or audio.

3. The system of claim 1, wherein the event data is an event name.

4. A system comprising:
a content database that stores content that is generated by a content producer computing device;
a processor that defines an event according to event data, establishes a start time for the event, associates a content item from the content database with the event, reschedules the content item in real time after the start time, receives a polling request for content, and determines content to be played at a time associated with the polling request; and
a transmitter that transmits the content item at a time corresponding to the time span added to the start time.

5. The system of claim 4, wherein the processor receives an event identifier that identifies the event such that the processor retrieves the event to transmit the content item corresponding to the event.

6. The system of claim 5, wherein the processor composes a live event manifest, the live event manifest comprising the event identifier and a session identifier.

7. The system of claim 7, wherein the polling request includes the event identifier and the session identifier.

8. The system of claim 4, wherein the transmitter also transmits formatting data corresponding to the content.

9. The system of claim 4, wherein the content is video and/or audio.

10. The system of claim 4, wherein the event data is an event name.
